(19) United States
(12) Patent Application Publication
(10) Pub. No.: US 2012/0244489 A1
(43) Pub. Date: Sep. 27, 2012

(54) ULTRASONIC ORTHODONTAL MONITORING SYSTEM AND METHOD

(76) Inventor: Robert D. Carnahan, White Salmon, WA (US)

(21) Appl. No.: 13/072,352

(22) Filed: Mar. 25, 2011

(51) Int. Cl. A61C 19/04

(52) U.S. Cl. 433/25; 433/215

(57) ABSTRACT

An ultrasonic orthodontal monitoring system and method of use is described herein, featuring an intraoral ultrasonic transducer and an ultrasonic monitoring apparatus configured to connect to the intraoral ultrasonic transducer, generate and send electrical pulse signals to the intraoral ultrasonic transducer, receive measured signals from the intraoral ultrasonic transducer, and generate time-of-flight and relative density based on the measured signals. This invention will permit routine measurements to be made of osseointegration by the patient's dentist during regular maintenance appointments, thereby reducing the risk of a failed implant, patient discomfort, and inconvenience. As a diagnostic tool, it can also aid in the diagnosis and treatment of progressive periodontal disease, peri-implantitis, and osteoporosis in edentulous patients.

### FIELD OF THE INVENTION

The present invention relates to dental prosthetics. More particularly, the present invention relates to a system and method for monitoring an osseointegration stage of a bone graft used with dental implantation and prosthetics placement.

### BACKGROUND

The most commonly used dental implants are titanium alloy screws that date to Italian clinical use in 1959 by Dr S. M. Tremonte. In Gothenburg, Sweden, 1965, Dr. Per-Ingvar Br [symbol] nemark placed the first human titanium dental implant. Over the past 50 years, oral and maxillofacial surgeons around the world continue studies relating to failure mechanisms of implants relative to the timing of placement post extraction, physical state of the region requiring grafting, patient physiology and health, and mechanical loading capability of the implant and prosthesis over time. More recently, ceramic zirconium oxide implants have gained some popularity over the metal alloy counterparts as they may offer greater biocompatibility.

The typical procedure involves extraction of the tooth to be replaced followed by a bone graft in the socket. It is critical to ensure sufficient maxillary or mandibular bone mass to accept drilling and secure placement of the implant. A variety of materials used for grafting include bovine bone, processed cadaver bone, autograft patient bone, and synthetic hydroxyapatite. The oral surgeon prepares the site, places the graft material, and sutures the site to permit healing and osseointegration. Normally a period of several months is required to ensure regeneration of live vascular bone with sufficient mass and density for the site to be drilled for placement of the implant. No common device technology is available to guide the oral surgeon on accurately choosing the incubation time necessary to ensure a high degree of implant stability. Incubation time is generally selected based on guesswork informed by experience.

A Columbia University College of Dental Medicine review conducted in 2005 found that incubation times in a range of 6 to 12 months were generally selected for bone augmentation procedures. Not uncommonly, incubation times of as little as two months were selected. Too short incubation times can necessitate repetition of the bone graft in order to achieve implant stability. A repetition of the procedure can require as much as an additional 18 months at added cost and inconvenience for both surgeon and patient, as well as serious social and personal discomfort.

The use of ultrasonic sensing systems became widely used in the early '70s for quality control of high volume industrial products, especially in identifying internal defects that might lead to failure. Much more recently, use of ultrasonic sensing in medical diagnostics has increased. The absence of exposure to physically harmful ionizing radiation has been a driving factor, even as X-ray, CAT and MRI systems persist as widely employed tools.

While ultrasonic sensing systems exist in the field of dentistry and dental implantology, with few exceptions, they are not well known or widely used. For wide practical analytical or diagnostic use, an ultrasonic sensing system should be no more complex to implement than routine production of x-rays by a dental technician or assistant. A discussion of the known art follows:

U.S. Pat. No. 5,564,423 teaches the use of a caliper pair of ultrasonic transducers for the external measurement of bone density in a bone segment e.g. finger, arm, leg but does not disclose intraoral use for dental implantation, diagnosis or monitoring of maxilla and mandibular areas of interest.

U.S. Pat. No. 6,702,746 teaches the use of a single ultrasonic probe placed in a cavity in the alveolar bone or on the surface of the posterior maxilla or mandible to measure the thickness of bone remaining between the cavity base and the alveolar canal to gauge its depth and to prevent drilling into the canal. The disclosed configuration is specific to measuring distances from an existing cavity socket or drill site and the alveolar canal.

U.S. Pat. No. 6,086,538 teaches transmission of an ultrasonic wave through the jawbone and measuring the reflected wave with the same transducer. The application requiring multiple placement positions of the transducer is used to locate cancaneus defects in the bone. The technique is virtually identical to that used for detection of internal porosity in metal castings. It has limited suitability for intraoral applications owing to size and complexity.

U.S. Pat. No. 6,030,221 teaches a system similar to that of the '538 patent discussed above, in that it also applies to location of jawbone bone defects. The '221 patent teaches application of color coding based on relative pulse intensities, mapping a 4×4 color coded image representing the attenuation of sound through the region of interest. This too is limited in adaption to the needs of monitoring the course of osseointegration of a bone graft preceding placement of an implant.

U.S. Pat. No. 7,285,093 introduces an improved 3D imaging system utilizing arrays of ultrasonic transducers with 6 degrees of freedom permitting virtually spherical data production for constructing a 3D image. The software used in producing and displaying the 3D image is analogous to that used in Dental CAT scanning now in common use. Its complexity and large capital investment will limit its use, particularly by smaller independent dental practices.

U.S. Pat. No. 4,296,349 teaches a method for fabrication of a diagnostic ultrasonic transducer utilizing piezoelectric polymers e.g. polyvinylidene difluoride, PVDF. The '349 patent lacks examples of uses or applications.

US Patent Publication No.: 2004-40249285 teaches a method of fabrication of a composite transducer on a flexible base substrate. The flexible substrate enhances transmission and reception of acoustical waves from curved or modulated surfaces. Showing less signal attenuation, improved signal strength, and measurement.

U.S. Pat. No. 6,720,709 teaches a method for manufacture of a miniature transducer with a flexible piezoelectric layer, e.g. PVDF, and switching circuitry to permit modulation of its mechanical impedance in use as an ultrasonic wave transmitter.

U.S. Pat. No. 6,946,777 teaches a method for manufacture of a composite polymer film transducer and bandwidth control for use in determining the speed of sound in low density media. PVDF improves impedance matching for sound wave propagation in liquid and gaseous media.

### SUMMARY AND ADVANTAGES

Embodiments of ultrasonic orthodontal monitoring systems and methods are described herein. Such systems and methods are intended for use in the field of dentistry, particularly relating to practices of grafting natural or synthetic bone into a socket in the maxilla and/or mandibula of the jawbone following a dental extraction. In particular, these systems and methods are intended for use in measuring suitability of a graft for drilling and acceptance of an implant. The suitability of the graft for subsequent processing may be evaluated based on its relative density, which indicates degree of graft osseointegration. Relative density of the bone graft can be determined by transmitting an ultrasonic wave through the bone graft and measuring the transit time of the ultrasonic wave. Since it has been long known that the density of a solid is inversely proportional to the square of the velocity of sound in the solid, it follows that the density is directly proportional to the time of flight squared for an ultrasonic wave to transit a known thickness through a solid. Thus the relative density of a bone graft as a function of time can be monitored by comparing a series of time of flight (TOF) measurements performed over the entire course of the implantation process, beginning immediately prior to extraction, bone grafting the socket cavity, monitoring approach to mature endpoint density , and implant placement.

This invention will permit routine measurements to be made during osseointegration by the patient's dentist during regular maintenance appointments reducing the risk of a failed implant, patient discomfort, and inconvenience. As a diagnostic tool, it can also aid in the diagnosis and treatment of progressive periodontal disease, peri-implantitis, and osteoporosis in edentulous patients.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1(a) illustrates the left side view of a jawbone with a mandibular ridge having a tooth socket following an extraction and prior to placement of a bone graft.

FIG. 1(b) illustrates a cross section of the tooth socket of FIG. 1(a) showing retracted surrounding soft gum tissue prior to bone graft emplacement.

FIG. 2(a) illustrates the tooth socket following placement of a bone graft and prior to drilling for implant placement.

FIG. 2(b) illustrates a threaded biocompatible metal alloy or ceramic implant placed into a drilled and internally threaded hole in a mature bone graft.

FIG. 3(a) illustrates an embodiment of an intraoral ultrasonic transducer.

FIG. 3(b) illustrates an alternative embodiment of an intraoral ultrasonic transducer with matched piezoelectric elements forming transducer pairs of a 2×2 matrix array.

FIG. 4(a) illustrates the placement of an intraoral ultrasonic transducer closely fitted over the mandibular ridge, including a tooth to be extracted and adjacent teeth.

FIG. 4(b) illustrates ultrasonic paths from an element of a 2×2 matrix array transmitter to each element of a 2×2 matrix array receiver.

FIG. 5 is a block diagram of an embodiment of an ultrasonic orthodontal monitoring system 52.

### REFERENCE NUMBERS USED IN DRAWINGS

Turning now descriptively to the drawings, in which similar reference characters denote similar elements throughout the several views, the figures illustrate embodiments of the present invention. With regard to the reference numerals used, the following numbering is used throughout the various drawing figures:

10 jaw bone

12 mandibular ridge

14 tooth socket

16 soft tissue

18 bone tissue

20 bone graft

22 apposition surface

26 threaded implant

30 intraoral ultrasonic transducer

32 flexible substrate

34 piezo element

36 transducer connector

38 16 pin transducer connector

40 piezo array

42 2×2 intraoral ultrasonic transducer

44 encapsulating layer

45 transmitting piezo array

46 receiving piezo array

48 extraction tooth

50 adjacent teeth

52 ultrasonic orthodontal monitoring system

56 ultrasonic monitoring apparatus

58 pulse generator

60 apparatus connector

62 piezo element acting as transmitter

64 piezo leads

66 piezo element acting as receiver

68 signal processor

70 data storage

72 display

74 control processor

76 instruction memory

78 control lines

80 data switch

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

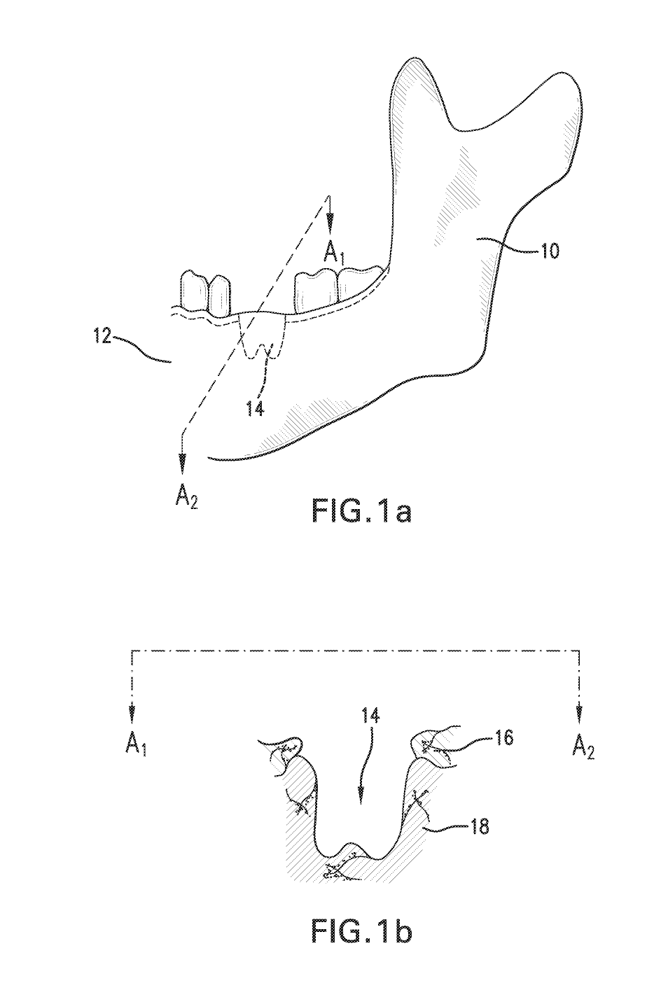

FIG. 1(a) illustrates a left side of a jawbone 10. The jawbone 10 has a mandibular ridge 12 including various teeth. The mandibular ridge 12 has a tooth socket 14 that previously held a tooth before the tooth was extracted. FIG. 1(b) illustrates a cross section of the jawbone 10 through the center of the tooth socket 14, showing soft tissue 16 and bone tissue 18 parts of the mandibular ridge 12.

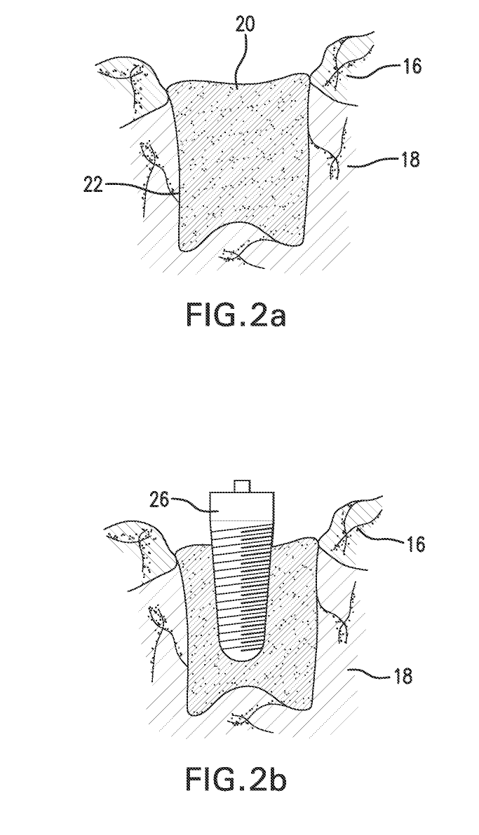

FIG. 2(a) illustrates the insertion of a bone graft 20 into the tooth socket 14, including an apposition surface 22 between the mandibular ridge 12 and the bone graft 20. The bone graft 20 may be harvested bone material known in the art. Before bone graft 20 is ready to support an implant, the bone graft 20 and the adjacent bone tissue 18 have to sufficiently integrate with each other in a process known as osseointegration. Both the bone graft 20 and the adjacent bone tissue 18 should each achieve a sufficient bone density to support the implant. The time it takes for bone graft 20 to sufficiently integrate with adjacent bone tissue 18 can vary from as few as 2 months to greater than a year. Attempting an implant installation in the bone graft 20 when the bone density of the bone graft 20 and the adjacent bone tissue 18 is insufficient may cause the installation to fail and require that the unsuccessful bone graft 20 be removed, the tooth socket 14 be re-prepared, and another bone graft 20 be inserted into the tooth socket 14. This repetition of the bone grafting process may be both expensive and time consuming.

FIG. 2(b) shows bone graft 20 of FIG. 2(a) following drilling and placement of a threaded implant 26. The threaded implant 26 may be of biocompatible metallic alloy, such as titanium, ceramic, or some other suitable material. A dental prosthesis may be thereafter coupled to the threaded implant 26. The threaded implant 26 will only be successful if the bone graft 20 supporting it is mature, i.e., the bone graft 20 has sufficient osseointegration with adjacent bone tissue 18 and sufficient bone mass and density.

Traditionally, the determination of whether or not the bone graft 20 is properly integrated is largely subjective and based solely on the experience of the dental practitioner. Further, improper maturation and integration may only become apparent after the dental prosthesis coupled to the threaded implant 26 fails (e.g., by the threaded implant 26 at least partially detaching from the bone graft 20 and/or the bone graft 20 at least partially detaching from the bone tissue 18 in the tooth socket 14). The failure may be accompanied by discomfort and pain in addition to the time lost waiting for the initial bone graft 20 to mature and for a replacement bone graft 20 to do the same. One solution to the problem of determining when osseointegration is sufficient may be to simply wait a conservatively long period of time, one longer than most all bone grafts have been observed to require. This solution is inefficient it forces all patients to wait a long time, when some may be ready for implantation earlier.

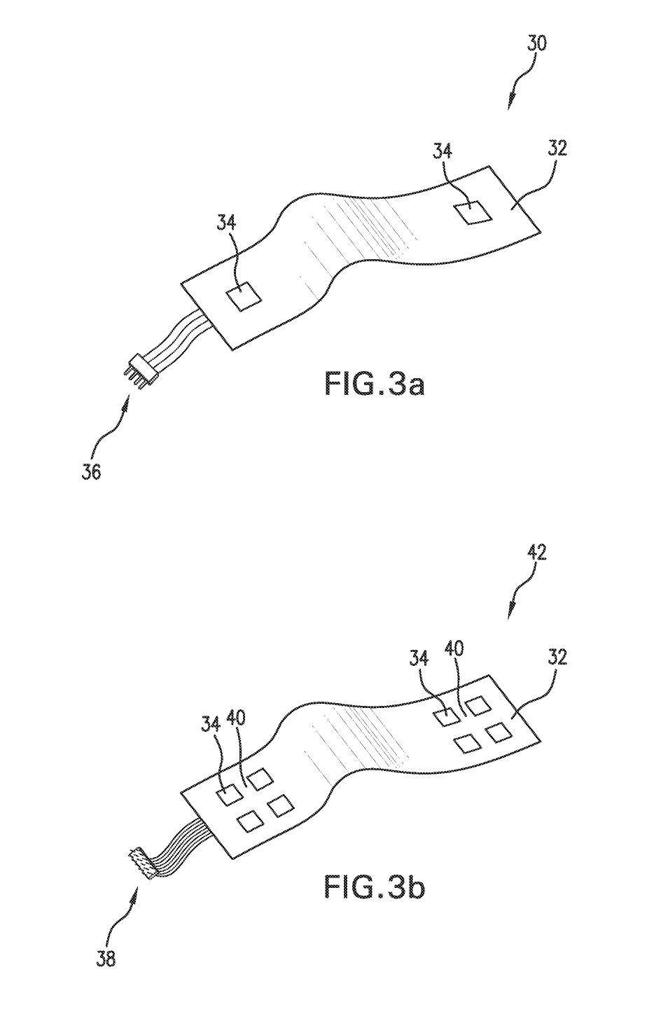

FIG. 3(A) shows an embodiment of an intraoral ultrasonic transducer 30. The intraoral ultrasonic transducer 30 has at least one pair of matched piezo elements 34. The piezo elements 34 are held in place within the intraoral ultrasonic transducer 30 so that when the intraoral ultrasonic transducer 30 is placed in a desired location on the mandibular ridge 12 over a region of interest, then the piezo elements 34 of each matched pair are in desired positions on opposing sides of the region of interest. The region of interest in most cases includes the tooth socket 14 and a region of bone tissue 18 around the tooth socket 14. However, the intraoral ultrasonic transducer 30 may be used to make measurements of regions of interest that do not include the tooth socket 14 or the region of bone tissue 18 around the tooth socket 14.

In this embodiment, the piezo elements 34 are coupled to a flexible substrate 32 configured to hold the piezo elements 34 in place within the ultrasonic transducer 30. In other embodiments, described later herein, the intraoral ultrasonic transducer 30 does not have the flexible substrate 32 and the piezo elements 34 are held in place by other means. Each piezo element has a pair of electrical leads (not shown) that electrically connect that piezo element with a transducer connector 36. Suitable dimensions for the intraoral ultrasonic transducer 30 and its components are determined by cataloguing measurements from dental impressions utilizing routine dental practice for crowns, implants, and the like.

In some embodiments, the piezo elements 34 are flexible piezopolymers such as polyvinylidene difluoride (PVDF). The flexibility of the piezo elements 34 enhances the overall flexibility of the intraoral ultrasonic transducer 30. In other embodiments, the piezo elements 34 may be ceramic piezoelectric elements such as PZT, Lead-Zirconate-Titanate.

In some embodiments, the piezo elements 34 are discrete, made separately from the flexible substrate 32 and later coupled thereto by adhesive bonding, lamination, or other means. In other embodiments, the piezo elements 34 and flexible substrate 32 are fabricated together using thin film deposition techniques. The layered film deposition technique includes starting with a base substrate, followed by lamination or deposition of a lower electrode, then deposition of a piezoelectric film, then deposition of an insulating layer to prevent electrode shorting, and then deposition of an upper electrode.

The flexible substrate 32 is configured to wrap over teeth in the mandibular ridge 12 in the mouth of a patient. Preferably, the piezo elements 34 are coupled to flexible substrate 32 on a side that is not adjacent to the mandibular ridge 12 to allow a snug and smooth contact and precise placement of the intraoral ultrasonic transducer 30.

To allow the flexible substrate 32 to be sufficiently flexible to wrap over the teeth of the mandibular ridge 12, a suitable material must be selected. One suitable material is DuPont's Kapton polyimide film developed specifically for micro-circuitry and amenable to bending or shaping over a toothy ridge. Other suitable materials include photopolymerizable Thiolene monomer liquid adhesive film, Nippon Mektron 3D formable liquid crystal polymer flexible substrate, or the like.

FIG. 3(B) shows an alternative embodiment of the intraoral ultrasonic transducer 30, specifically a 2×2 intraoral ultrasonic transducer 42. The 2×2 intraoral ultrasonic transducer 42 is similar to the intraoral ultrasonic transducer 30 shown in FIG. 3(A), having a flexible substrate 32, but instead of the single pair of piezo elements 34, it has 4 matched pairs of piezo elements 34 in 2×2 piezo arrays 40 and instead of a four pin transducer connector 36, it has a 16 pin transducer connector 38. A larger or differently dimensioned array of piezo elements 34 will allow monitoring of a larger or differently shaped region of interest. A person of skill in the art would realize that other embodiments of the intraoral ultrasonic transducer 30 can have other numbers of piezo elements 34 and piezo arrays 40 with other dimensions, such as 1×2 or 3×3.

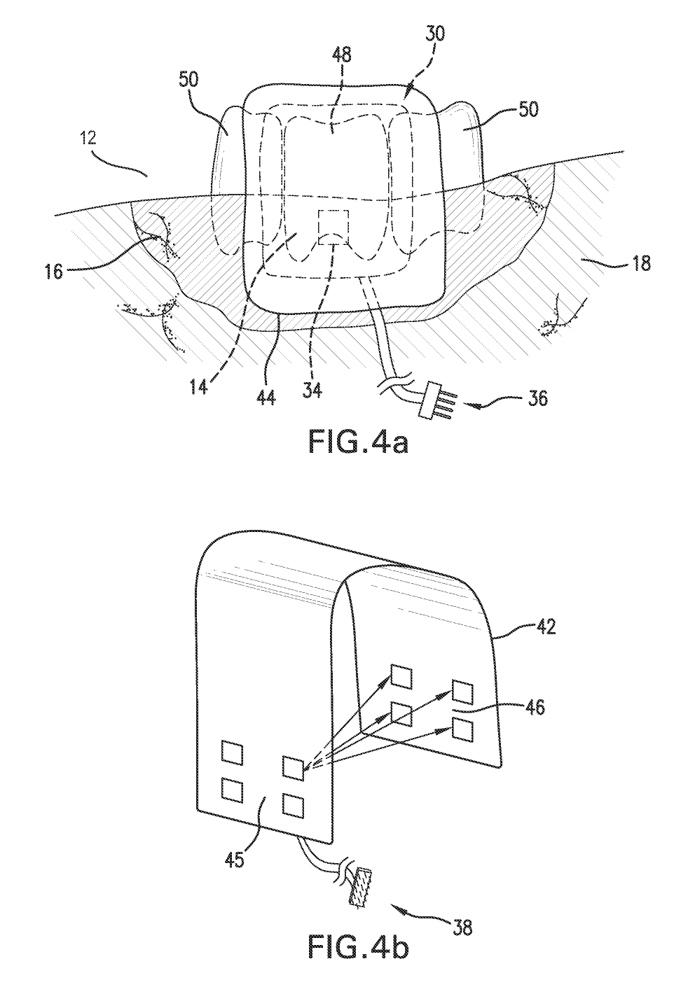

FIG. 4(a) illustrates how the intraoral ultrasonic transducer 30 is capable of being closely fitted over the mandibular ridge 12, including a tooth to be extracted (extraction tooth 48) and adjacent teeth 50. The intraoral ultrasonic transducer 30 can be placed over the mandibular ridge 12 such that the piezo elements 34 of each matched pair are in the desired positions on opposing sides of the region of interest. So positioned, the intraoral ultrasonic transducer 30 can be used to determine relative bone density.

To determine relative bone density, the intraoral ultrasonic transducer 30 sends ultrasonic waves though the region of interest in the mandibular ridge 12. One of the matched pair of piezo elements 34 acts as an ultrasonic transmitter and the other as a receiver. A time-of-flight (TOF) through the region of interest is measured for each of the ultrasonic waves. A time of flight principle is then used to calculate relative bone density.

Time of flight is proportional to the velocity of sound in a particular solid. For example, the velocity of sound in a solid C=(E/ρ)^{1/2} where C is the velocity of sound in the medium, E is the modulus of elasticity, and ρ is the density. For a given distance L in the solid, C may also be obtained by measuring the transit time or time of flight (TOF) for a sound wave to propagate through the solid, then dividing the distance L by time of flight TOF, or: C=L/TOF. Substituting for C, one can see that: L/TOF=(E/ρ)^{1/2}. Squaring both sides of the equation yields: (L/TOF)²=E/ρ. Assuming that L and E remain substantially constant for a particular measurement, then it is clear that the density ρ is directly proportional to (TOF)². Thus for a given solid and dimension L, relative density is defined as the square of density ρ₁ (density at time t₁) divided by the square of density ρ₀ (density at initial time t₀), or: Relative density=ρ₁/ρ₀=(TOF(t₁)/TOF(t₀))², where TOF(t₀) is the time of flight at the initial time and TOF(t₁) is the time of flight at time t₁. Typically, initial time t₀ is a time before extraction, time t₁ is some time after extraction and bone graft placement.

Relative density is a metric that a dental practitioner can use to judge bone graft maturity. Relative density above a relative density threshold indicates the bone graft is sufficiently mature to hold an implant. A relative density threshold of 95% or more indicates mature endpoint density. Some dental practitioners may decide to use different values for the relative density threshold, depending on their experience. Periodic measurements taken every 2 weeks or so over a minimum of 3 to 4 months will permit determination of bone graft 20 rate of growth, which in turn will permit a prediction of a time required to reach mature endpoint density.

The intraoral ultrasonic transducer 30 can be used for periodic measurements of relative bone density throughout the process of extraction, bone grafting, and implant placement. To aid reproducibility and accuracy of relative bone density measurements, some embodiments of the intraoral ultrasonic transducer 30 have an encapsulating layer 44 coupled to the flexible substrate 32 and piezo elements 34. The encapsulating layer 44 is configured to hold the piezo elements 34 in the desired positions on the mandibular ridge 12. This will allow the intraoral ultrasonic transducer 30 to be removed and placed back in the exact same position multiple times following extraction for monitoring of re-growth of live vascular bone in the region of interest and the osseointegration of the bone graft 20.

In some embodiments, the intraoral ultrasonic transducer 30 is made by placing unsolidified dental impression material over the flexible substrate 32 and mandibular ridge 12 while the flexible substrate 32 and piezo elements 34 are in the desired positions on the mandibular ridge 12. The dental impression material extends onto and over the extraction tooth 48 as well as at least a portion of the adjacent teeth 50, conforming to the surfaces thereof, and forming the encapsulating layer 44. As the dental impression material of the encapsulating layer 44 solidifies, it bonds to the flexible substrate 32 and piezo elements 34. The dental impression material may be any material commonly used for dental impressions, such as sodium alginate, polyether and silicones.

In some embodiments, the intraoral ultrasonic transducer 30 is made from a cast of the region of interest. Dental impression material is placed over the mandibular ridge 12 to form an impression mold. Preferably, the impression mold should include an impression of the entire mandibular ridge 12, including all teeth therein. At least, the impression mold should include an impression of the extraction tooth 48 as well as at least a portion of the adjacent teeth 50. The cast is then made using the impression mold and plaster of Paris or some similar material. The cast is thus a replica of the mandibular ridge 12. The piezo elements 34 are then placed in positions on the cast that match the desired positions on the mandibular ridge 12. Dental impression material is pressed onto the cast of the mandibular ridge 12, forming the encapsulating layer 44. A preferred dental impression material for this purpose is polymerized siloxane (silicone), but other dental impression material may be used. In some embodiments, the piezo elements 34 are held in place with a weak adhesive while the encapsulating layer 44 is formed. In some embodiments, the flexible substrate 32 holds the piezo elements 34 in place. As the dental impression material solidifies, it bonds to the flexible substrate 32, if present, and to the piezo elements 34. The intraoral ultrasonic transducer 30 can then be removed from the cast and placed on the mandibular ridge 12. So constructed, the intraoral ultrasonic transducer 30 can be removed and replaced repeatedly for periodic monitoring relative bone density.

In another embodiment of this invention, the intraoral ultrasonic transducer 30 is made by placing the piezo elements 34 inside a dental impression tray, filling the tray with the dental impression material, then placing the tray over the patient's mandibular ridge 12 so that the piezo elements 34 are in the desired positions on the mandibular ridge 12. The dental impression material solidifies, forming the encapsulating layer 44. After the dental impression material solidifies, the intraoral ultrasonic transducer 30 can be removed and placed back in the exact same position multiple times following extraction for monitoring relative bone density.

In another embodiment of this invention, the intraoral ultrasonic transducer 30 is made with materials that are curable utilizing ultraviolet (UV) light. Specifically, the flexible substrate 32 is made of materials that are moldable and curable. The flexible substrate 32 is moldable in the sense that it can readily be bent into a certain shape and will maintain that shape until bent again. Following placement of the flexible substrate 32 over the mandibular ridge 12, including the extraction tooth 48 and adjacent teeth 50, the flexible substrate 32 is subjected to UV light. The UV light cures the flexible substrate 32 and creates a negative replica of the mandibular ridge 12 over the region of interest. The flexible substrate 32 after curing is no longer moldable and will retain its cured shape, but will still have some flexibility. That is, the cured flexible substrate 32 can be bent, but will return to its cured shape when bending forces are released. This embodiment will also permit the intraoral ultrasonic transducer 30 to removed and placed back in the exact same position multiple times following extraction for monitoring of the region of interest. To be moldable and curable, the flexible substrate 32 is made of partially photopolymerized adhesive Thiolene film or some other similar material. Use of flexible substrates 32 that are moldable and curable reduces the need for the encapsulating layer 44. In some embodiments, the encapsulating layer 44 is still used in conjunction with flexible substrates 32 that are moldable and curable. In other embodiments, the encapsulating layer 44 is dispensed with when using flexible substrates 32 that are moldable and curable.

FIG. 4(b) shows the 2×2 intraoral ultrasonic transducer 42 of FIG. 3(b) in the process of taking a measurement. The 2×2 intraoral ultrasonic transducer 42 has a transmitting piezo array 45 configured to be electrically pulsed, consequently transmitting ultrasonic waves. On the other side, the 2×2 intraoral ultrasonic transducer 42 has a receiving piezo array 46 configured to receive the ultrasonic waves and convert them into electrical signals. Typically each of the piezo elements 34 in the transmitting piezo array 45 are pulsed sequentially. After one of the piezo elements 34 pulses, the four piezo elements 34 in the receiving array receive the ultrasonic wave, each typically receiving at slightly different times due to differences in the length of the path between the transmitting and receiving piezo elements 34 and the density of the material inbetween them. Using two 2×2 arrays pulsed in a single direction results in 16 discrete measurements, four measurements for each pulse duration of the four transmitter elements in one direction. The transmitting and receiving functions of opposite sides of the 2×2 intraoral ultrasonic transducer 42 can be switched to enable signals to be transmitted though the region of interest in opposite directions to double the number of measurements from each ultrasonic pulse transmission. This allows for an option of a total of 32 discrete measurements and helps to reduce transducer positioning error. Larger arrays capable of further reducing measurement scatter are possible. Larger arrays extending laterally to regions adjacent to the bone graft 20 can serve as a calibration index for comparison to the grafted area itself.

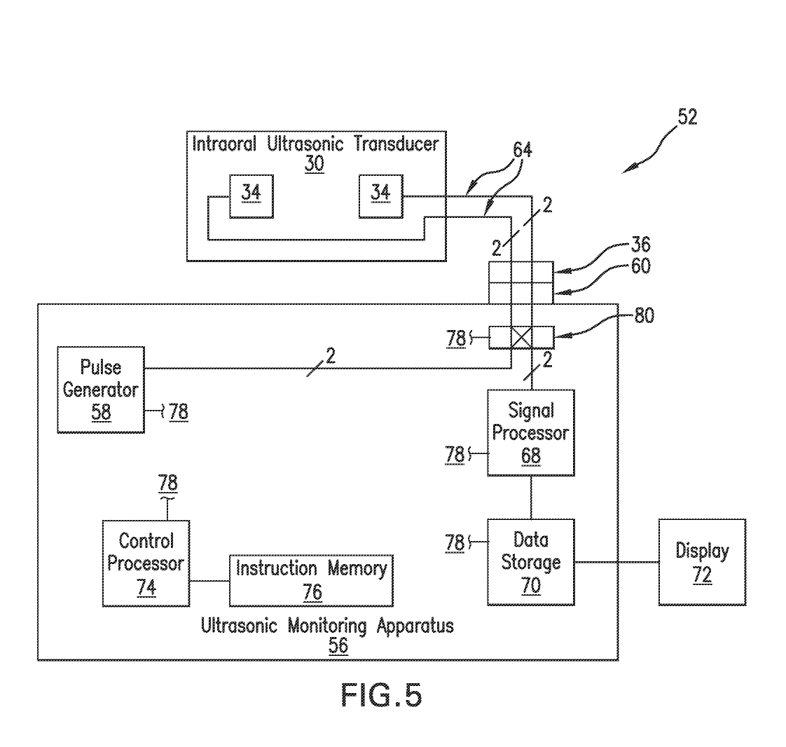

FIG. 5 is a block diagram of an embodiment of an ultrasonic orthodontal monitoring system 52. The ultrasonic orthodontal monitoring system 52 comprises an ultrasonic monitoring apparatus 56 and the intraoral ultrasonic transducer 30 described above.

The ultrasonic monitoring apparatus 56 has an apparatus connector 60 that is configured to electrically connect to the transducer connector 36. Piezo element leads 64 within the intraoral ultrasonic transducer 30 are routed from the piezo elements 34 through the transducer connector 36 and apparatus connector 60. Each piezo element 34 has its own pair of piezo element leads 64, including a signal lead and a return lead. In the embodiment shown in FIG. 5, the flexible transducer has a single pair of piezo elements 34. Thus, it has 2 pairs of piezo element leads 64 and the transducer connector 36 and apparatus connector are at least four pin connectors. In other embodiments, the intraoral ultrasonic transducer 30 has two or more pairs of piezo elements 34, and will thus have proportionally more pairs of piezo element leads 64 and a transducer connector with a higher pin count. For example, the 2×2 intraoral ultrasonic transducer 42 shown in FIG. 3(b) has 8 pairs of piezo element leads 64 and the transducer connector 36 and the apparatus connector 60 in such an embodiment has at least 16 pin connectors.

The ultrasonic monitoring apparatus 56 has a pulse generator 58, a apparatus connector 60, a signal processor 68, a data switch 80, data storage 70, a control processor 74, instruction memory and control lines 78. The pulse generator 58 is configured to generate electrical pulse signals. The pulse signals are carried on internal leads to the data switch 80. Suitable pulse generators are well known in the art, such as Maxim's MAX4644.

The data switch 80 routes the pulse signals over piezo element leads 64 to one of the piezo elements 34, which converts the electrical pulse signals to ultrasonic waves. The ultrasonic waves pass through the region of interest in the mandibular ridge 12 (see FIGS. 4(a) and 4(b)). Another of the piezo elements 34 receives the ultrasonic waves and converts them into a measured signal, which is once again electrical. Other piezo element leads 64 carry the measured signal back through the data switch 80 which carries it to the signal processor 68.

The signal processor 68 calculates time-of-flight and relative density according to the formulas discussed above based on a time difference between when the pulse signal was generated and when the measured signal was received. The signal processor 68 determines a time when the pulse signal was generated by receiving a copy of the pulse signal split off on its way to the intraoral ultrasonic transducer 30. In other embodiments, the signal processor 68 determines the time when the pulse signal was generated based on a copy of a command signal from the control processor 74 to the pulse generator 58 that orders a pulse be generated. Once the signal processor 68 has calculated time-of-flight information and relative density, it sends this information to data storage 70. In some embodiments the signal processor 68 is a National Instruments NI system based on a SCM single chip microcomputer programmed with Labview Software to provide a capability to produce real time and archival records for full use of the ultrasonic measurements. In other embodiment, other components may be used for the signal processor 68.

Some embodiments of the ultrasonic orthodontal monitoring system 52 include a display 72 configured to connect with the ultrasonic monitoring apparatus 56. The display 72 in some embodiments is a Liquid Crystal Display (LCD). In other embodiments, the display 72 is a printer or some other device that can be used to present information.

The control processor 74 is configured to send control signals to other components of the ultrasonic monitoring apparatus 56 over control lines 78. The instruction memory is configured to hold instructions for the control processor 74 regarding operation of the ultrasonic monitoring apparatus 56.

In embodiments where the intraoral ultrasonic transducer 30 has more than a single pair of piezo elements, the control processor 74 coordinates when sequential pulse signals are generated, and prior to each pulse signal, instructs the data switch 80 to which piezo element 34 that pulse signal is to be routed and which piezo elements 34 are to be connected to the signal processor 68.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

1. An intraoral ultrasonic transducer comprising:
a flexible substrate configured to be wrapped over a mandibular ridge inside a mouth of a patient; and
a first pair of piezo elements coupled to the flexible substrate such that when the flexible substrate is wrapped over a desired location on the mandibular ridge, then the piezo elements of the first pair will be in desired positions on opposing sides of a region of interest in the mandibular ridge.

2. The intraoral ultrasonic transducer of claim 1, wherein the flexible substrate is moldable and curable.

3. The intraoral ultrasonic transducer of claim 1, wherein the flexible substrate is made of polyimide.

4. The intraoral ultrasonic transducer of claim 1 further comprising an encapsulating layer configured to hold the first pair of piezo elements in the desired positions.

5. The intraoral ultrasonic transducer of claim 4, wherein the encapsulating layer is further configured to extend over a first tooth position and over at least a portion of a second tooth position and a third tooth position, the first tooth position coinciding with the region of interest, the second tooth position and third tooth position adjacent to the first tooth position.

6. The intraoral ultrasonic transducer of claim 1, wherein the piezo elements are flexible.

7. The intraoral ultrasonic transducer of claim 1, wherein the piezo elements are thin film elements.

8. The intraoral ultrasonic transducer of claim 1, wherein the piezo elements are thin film depositions on the flexible substrate.

9. The intraoral ultrasonic transducer of claim 1, wherein the piezo elements are made of polyvinylidene difluoride (PVDF).

10. The intraoral ultrasonic transducer of claim 1, wherein the piezo elements are made of ceramic.

11. The intraoral ultrasonic transducer of claim 1, wherein the piezo elements are made of Lead-Zirconate-Titanate.

12. The intraoral ultrasonic transducer of claim 1 wherein the first pair of piezo elements are coupled to the flexible substrate such that the flexible substrate can be wrapped over the desired location on the mandibular ridge such that the piezo elements of the first pair will define a line that passes through the region of interest.

13. The intraoral ultrasonic transducer of claim 1 further comprising a second pair of piezo elements coupled to the flexible substrate.

14. The intraoral ultrasonic transducer of claim 13 wherein the second pair of piezo elements are coupled to the flexible substrate such that the flexible substrate can be wrapped over the desired location on the mandibular ridge such that the piezo elements of the second pair will define a line that passes through bone tissue of the mandibular ridge, but not through a tooth socket.

15. An ultrasonic monitoring apparatus comprising:
a pulse generator configured to generate electrical pulse signals to send to an intraoral ultrasonic transducer; and
a signal processor configured to receive measured signals from the intraoral ultrasonic transducer, configured to generate relative density based on the measured signals.

16. The ultrasonic monitoring apparatus of claim 15 further comprising a data switch configured to sequentially route a first pulse signal to a first piezo element in a first piezo element array coupled to the intraoral ultrasonic transducer, then a second pulse signal to a second piezo element in the first piezo element array.

17. The ultrasonic monitoring apparatus of claim 16 wherein the data switch is further configured to sequentially route a third pulse signal to a third piezo element in a second piezo element array coupled to the intraoral ultrasonic transducer.

18. An ultrasonic orthodontal monitoring system, comprising:
an intraoral ultrasonic transducer; and
an ultrasonic monitoring apparatus configured to connect to the intraoral ultrasonic transducer, configured to generate electrical pulse signals to send to the intraoral ultrasonic transducer, configured to receive measured signals from the intraoral ultrasonic transducer, configured to generate time-of-flight and relative density based on the measured signals.

19. The ultrasonic orthodontal monitoring system of claim 18, wherein the intraoral ultrasonic transducer further comprises:
a flexible substrate configured to be wrapped over a mandibular ridge inside a mouth of a patient; and
a first pair of piezo elements coupled to the flexible substrate in positions such that when the flexible substrate is wrapped over a desired location on the mandibular ridge, then the first pair of piezo elements will be in desired positions with each piezo element of the first pair on opposing sides of a region of interest in the mandibular ridge.

20. The ultrasonic orthodontal monitoring system of claim 18, wherein the intraoral ultrasonic transducer further comprises:
an encapsulating layer of dental impression material configured to be placed over a mandibular ridge inside a mouth of a patient; and
a first pair of piezo elements coupled to the encapsulating layer such that when the encapsulating layer is placed over a desired location on the mandibular ridge, then the piezo elements of the first pair will be in desired positions on opposing sides of a region of interest in the mandibular ridge.

21. A method for measuring maturity of a bone graft comprising:
measuring an initial time-of-flight of ultrasonic waves through a region of interest in a mandibular ridge prior to extraction of a tooth from the region of interest;
measuring additional times-of-flight of ultrasonic waves through the region of interest at a plurality of times after extraction of the tooth;
calculating a plurality of relative densities of the region of interest, at least one at each of the plurality of times after extraction, based on the initial and additional times-of-flight; and
calculating an estimated time for a bone graft placed in the region of interest to reach mature endpoint density based on the plurality of relative densities.

22. The method of claim 21, further comprising:
placing, prior to extraction, an intraoral ultrasonic transducer in a desired location over the region of interest; and
replacing, prior to measuring additional times-of-flight, the intraoral ultrasonic transducer in the desired location over the region of interest.

23. The method of claim 22 wherein placing, prior to extraction, the intraoral ultrasonic transducer in the desired location over the region of interest further comprises:
wrapping a flexible substrate over the mandibular ridge; and
placing dental impression material over the flexible substrate to form an encapsulating layer.

24. The method of claim 22 wherein placing, prior to extraction, the intraoral ultrasonic transducer in the desired location over the region of interest further comprises:
wrapping a flexible substrate over the mandibular ridge; and
curing the flexible substrate with UV light.

25. The method of claim 22 wherein placing, prior to extraction, the intraoral ultrasonic transducer in the desired location over the region of interest further comprises:
placing dental impression material over the desired location on the mandibular ridge to form an impression mold;
making a cast from the impression mold;
placing piezo elements in positions on the cast that match desired positions adjacent to the region of interest in the mandibular ridge;
placing dental impression material over the cast; and
waiting for the dental impression material to set, thereby forming an encapsulating layer that couples to the piezo elements.

26. A method for constructing an intraoral ultrasonic transducer comprising:
placing dental impression material over a mandibular ridge in a desired location over a region of interest to form an impression mold;
making a cast from the impression mold;
placing piezo elements in positions on the cast that match desired positions adjacent to the region of interest in the mandibular ridge; and
placing dental impression material over the cast and the piezo elements, thereby forming an encapsulating layer that couples to the piezo elements when the dental impression material sets.

27. An intraoral ultrasonic transducer comprising:
a encapsulating layer of dental impression material configured to be placed over a mandibular ridge inside a mouth of a patient; and
a first pair of piezo elements coupled to the encapsulating layer such that when the encapsulating layer is placed over a desired location on the mandibular ridge, then the piezo elements of the first pair will be in desired positions on opposing sides of a region of interest in the mandibular ridge.

28. The intraoral ultrasonic transducer of claim 27, wherein the encapsulating layer is made of dental impression material.

29. The intraoral ultrasonic transducer of claim 27, wherein the encapsulating layer is made of silicone.
